(19) United States
(12) Patent Application Publication
(10) Pub. No.: US 2026/0340653 A1
(43) Pub. Date: Oct. 29, 2026

(54) SHADOW-AWARE DEPLOYMENT AND OPERATION OF UAV INFRASTRUCTURE

(71) Applicant: Wing Aviation LLC, Palo Alto, CA (US)

(72) Inventors: Domitille Commun, Washington, DC (US); Kyle Julian, Palo Alto, CA (US); Ali Shoeb, San Rafael, CA (US)

(21) Appl. No.: 19/193,009

(22) Filed: Apr. 29, 2025

(51) Int. Cl. G06Q 30/018

(52) U.S. Cl. CPC G06Q 30/018

(57) ABSTRACT

A technique for planning the deployment of a UAS ground asset of a UAV service to a physical site includes receiving a user prompt and system instructions by a site designer agent. The user prompt identifies the physical site and the UAS ground asset. The system instructions describe deployment policies and a tools library available to the site designer agent that facilitates deployment planning. Compliance maps are generated by the site designer agent using the tools library. The compliance maps each indicate a grid-based compliance of the physical site to an associated one of the deployment policies. An aggregated compliance map is generated for the UAS ground asset at the physical site based upon an aggregation of the compliance maps. Placement guidance indicating where to deploy the UAS ground asset at the physical site is generated based at least on the aggregated compliance.

### TECHNICAL FIELD

This disclosure relates generally to unmanned aircraft systems, and in particular but not exclusively, relates to intelligent placement and operation of unmanned aerial vehicle (UAV) infrastructure deployed to a site.

### BACKGROUND INFORMATION

An unmanned vehicle, which may also be referred to as an autonomous vehicle, is a vehicle capable of traveling without a physically present human operator.

Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby providing package pick-ups and deliveries almost anywhere.

Since UAVs configured for package delivery missions have a limited delivery range (e.g., 5-20 miles dependent upon package size and weight), a decentralized network of local storage nests and waypoint package pickup locations (aka UAV hubs) may need to be deployed over a region to service merchants and customers. When operating in and about these UAV hubs, reliable, high precision localization is often more important than the cruise segments between UAV hubs. As such, vision-based localization techniques may be used to supplement global navigation satellite system (GNSS) based localization techniques. Vision-based localization techniques can be negatively impacted by dynamic environmental factors, such as shadows.

Accordingly, intelligent placement and operation of UAV infrastructure that accounts for these dynamic environmental factors can increase the reliability, efficiency, and safety of UAV operations at UAV hubs.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A illustrates operation of an unmanned aerial vehicle (UAV) delivery service that delivers packages into a neighborhood, in accordance with an embodiment of the disclosure.

FIG. 1B illustrates unmanned aircraft system (UAS) ground assets of the UAV delivery service deployed at a physical site of a business, in accordance with an embodiment of the disclosure.

FIG. 1C illustrates how deployment planning of UAS ground assets should be shadow-aware, in accordance with an embodiment of the disclosure.

FIG. 2A is a functional block diagram illustrating components of a UAV delivery service, in accordance with an embodiment of the disclosure.

FIG. 2B is a functional block diagram illustrating deployment planning components of a UAV delivery service including a site designer agent and a tools library, in accordance with an embodiment of the disclosure.

FIG. 3 is a flow chart illustrating a process for deployment planning of UAS ground assets to a physical site, in accordance with an embodiment of the disclosure.

FIG. 4A illustrates how various compliance maps are aggregated to generate an aggregated compliance map, in accordance with an embodiment of the disclosure.

FIG. 4B illustrates ray casting of sunlight to map shadows onto a digital surface model (DSM), in accordance with an embodiment of the disclosure.

FIG. 4C illustrates various geospatial data available via a geostore including an overhead image, semantic segmentation, and an elevation map, in accordance with an embodiment of the disclosure.

FIG. 5A is a perspective view illustration of a UAV configured for use in a UAV delivery service, in accordance with an embodiment of the disclosure.

FIG. 5B is an underside plan view illustration of the UAV configured for use in the UAV delivery service, in accordance with an embodiment of the disclosure.

### DETAILED DESCRIPTION

Embodiments of a system and method for automated planning including shadow-aware deployment and operation of unmanned aerial vehicle (UAV) infrastructure are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

When deploying new UAV infrastructure of a UAV service to a local storage nest, waypoint package pickup location, or other physical site (also referred to as a UAV hub), a number of factors should be evaluated to ensure the UAV hub is robust to environmental influences, efficient to operate, and safe for employees and the public in the immediate vicinity. An example UAV service is a UAV delivery service that provides aerial package deliveries to customers. Example UAV infrastructure that may be deployed to a UAV hub of a UAV delivery service includes unmanned aircraft system (UAS) ground assets such as landing pads for staging/charging the UAVs, autoloader mechanisms adapted for transferring packages to the UAVs, fiducial navigation markers (e.g., AprilTags developed by the APRIL robotics lab at the University of Michigan) adapted for visual localization by the UAVs, or otherwise. The UAS ground assets should be placed on flat, level, durable surfaces (e.g., concrete, asphalt), and sufficiently offset from tall structures that may cast dark shadows onto the asset thereby adversely affecting vision-based perception systems. The UAS ground assets should have buffers from pedestrian paths (e.g., sidewalks, thoroughfares, ingress/egress points to buildings, etc.), not impede access to governmental infrastructure (e.g., fire hydrants, mailboxes, etc.), and avoid placement over dark backgrounds (e.g., black asphalt). All of these factors should be considered when planning the deployment layout of UAS ground assets at a given physical site.

Shadows can be strongly detrimental to vision-based perception systems. Shadows reduce the reliability of fiducial detection and identification used for vision-based localization. In fact, shadows can so fully obscure a fiducial navigation marker that vision-based perception systems may be unable to track the fiducial during specific hours of the day until shadows pass. In the case of autoloaders 112, shadows reduce the ability of the vision-based perception systems to detect key points used to determine the orientation of autoloaders 112. Conventionally, overcoming shadows cast on autoloaders 112 may require extensive re-training of ML detection models by incorporating shadow images in the training datasets. Such data collection and retraining is a significant engineering undertaking. Shadows can also reduce the accuracy of depth measurements from a stereovision camera, decrease reliability of semantic segmentation, and generally reduce the contrast and perception of these vision-based navigational aids.

Shadow-aware planning of UAS ground assets, as well as a shadow-aware operational use of these UAS ground assets once deployed, will make these UAV hubs more robust to environmental factors providing an improved user experience and reliable aerial delivery service. Embodiments disclosed herein describe a software tool that facilitates intelligent design, deployment, and operation of UAV hubs such as local staging nests and waypoint pickup locations. The software tool is user-friendly, accepting intuitive user requests, all while mitigating the impact of shadows and abiding by other safety, technological, and efficiency-based policies. These and other details are described below.

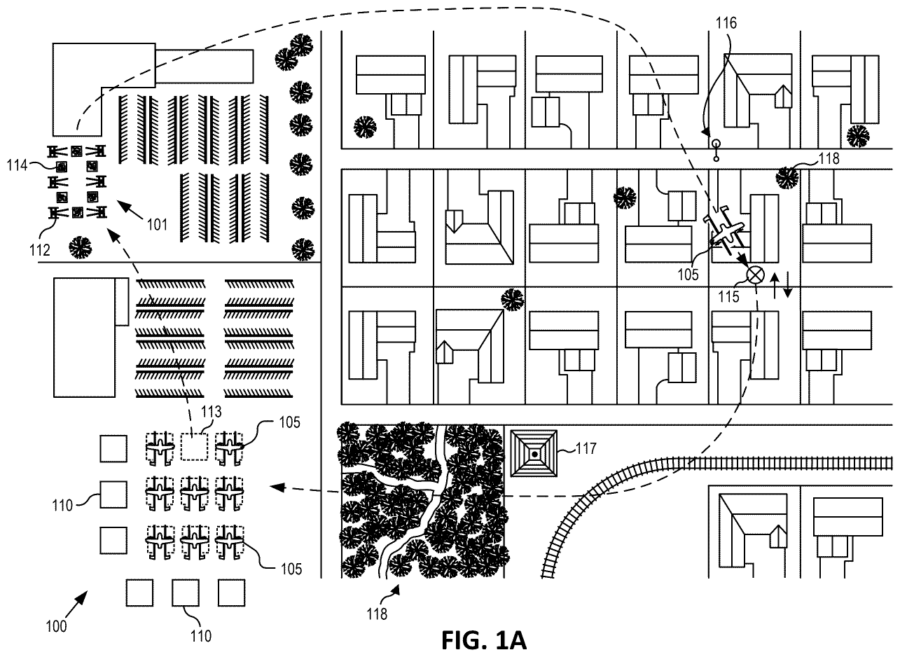

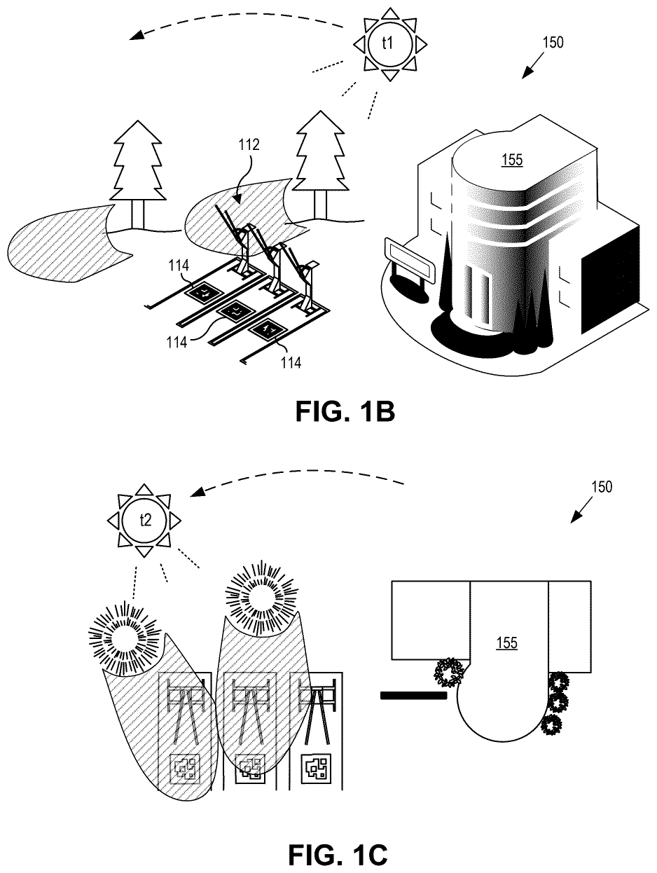

FIG. 1A illustrates operation of a UAV delivery service that delivers packages into a neighborhood, in accordance with an embodiment of the disclosure.

UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood where autoloader mechanisms 112 may be staged adjacent to the vendor facilities at a waypoint pickup area 101. In other embodiments, one or more UAVs 105 and staging pads 113 may also be hosted at an individual vendor property. An example aerial delivery mission may include multiple mission phases such as takeoff from terminal area 100 with a package for delivery to a destination area 115 (also referred to as a delivery zone, drop zone, or delivery destination), rising to a cruising altitude, and cruising to the destination area. Alternatively, UAV 105 may fly from terminal area 100 to waypoint pickup area 101 for package pickup from an autoloader mechanism 112, before continuing to destination area 115 for delivery. At destination area 115, UAV 105 drops off the package before cruising back to terminal area 100.

During the course of a delivery mission, ground-based obstacles are an ever-present hazard-particularly tall slender obstacles such as streetlights 116, telephone poles, radio towers 117, cranes, trees 118, and utility lines. To facilitate an efficient and safe operation of the UAV delivery service, these obstacles must be avoided while UAS ground assets should be reliably detected and accurately tracked. Global navigation satellite systems (GNSS), such as the global positioning system (GPS) in North America, may form a primary localization subsystem of UAVs 105 for navigating to assets and around obstacles. However, in some situations, the GNSS system may be unavailable or insufficiently accurate. Accordingly, vision-based navigation modules may be used to buttress GNSS by providing fallback localization and/or providing higher precision localization when and where necessary. For example, fiducial navigation markers 114 may be placed adjacent to autoloaders 112 at waypoint pickup area 101 to increase localization precision for package pickup from autoloader 112.

Conventionally, the layout and deployment of autoloaders 112 and fiducial navigation markers 114 at waypoint pickup area 101 is performed by a human designer. As UAV delivery services expand, it is anticipated that this layout planning may be performed by employees of the merchant vendor, who may not fully appreciate the full set of factors that should be considered-particularly the adverse impact of transient shadows that change by the season and the hour. For example, FIG. 1B illustrates a physical site 150 having a business 155 that has deployed autoloaders 112 for package pickups and fiducial navigation markers 114 to facilitate vision-based localization by UAVs 105. At time t1 (FIG. 1B), the UAS ground assets may be in full sun; however, at time t2 later in the day (FIG. 1C), one or more of the UAS ground assets may be fully or partially obscured by shadows. The software design tool described herein is capable of planning the layout of autoloaders 112 and fiducial navigation markers 114 at physical site 150 to not only account for transient shadows over the course of the day and during different seasons, but also account for many other factors that impact UAV operations.

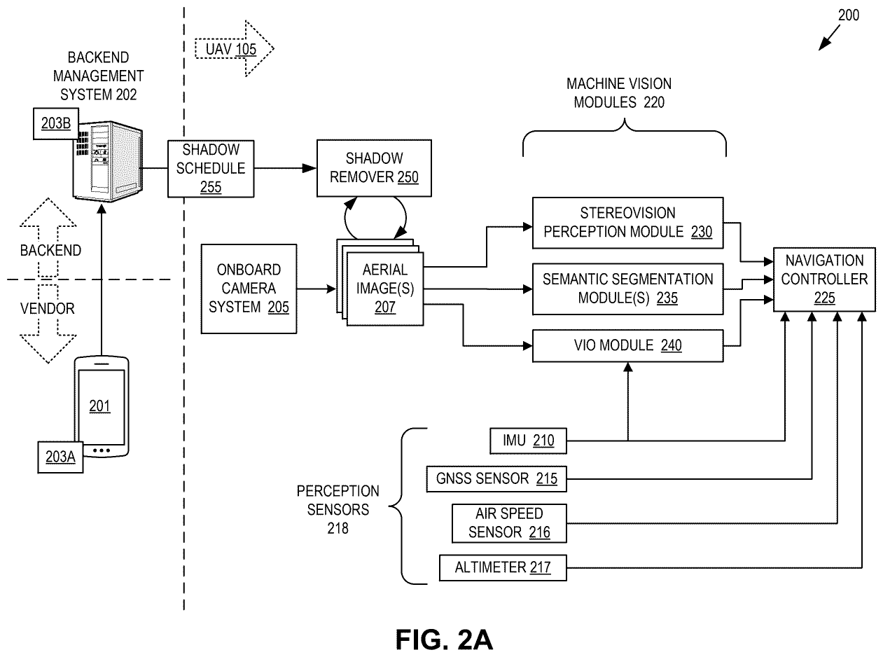

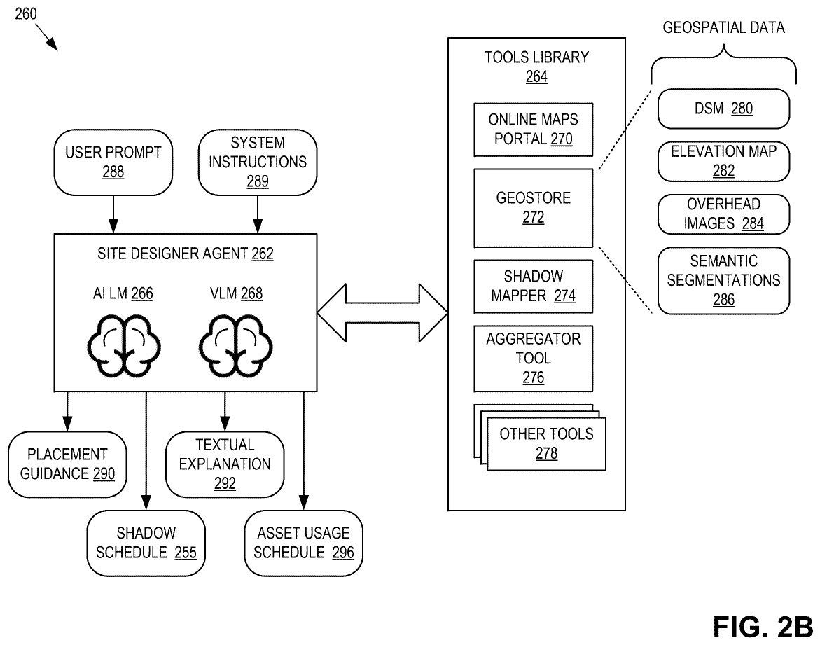

FIG. 2A is a functional block diagram illustrating a system 200 including components of a UAV delivery service, in accordance with an embodiment of the disclosure. System 200 includes many of the relevant software and hardware elements for deploying new UAS ground assets and supporting vision-based localization and navigation of UAVs 105 during delivery operations.

The components disposed onboard UAVs 105 include an onboard camera system 205 for acquiring aerial images 207, an inertial measurement unit (IMU) 210, a GNSS sensor 215, an air speed sensor 216 (e.g., pitot tube), an altimeter 217 (e.g., air pressure sensor), machine vision modules 220, and a navigation controller 225.

Collectively, the sensors 210-217 are referred to as perception sensors 218. The illustrated embodiment of machine vision modules 220 includes a stereovision perception module 230, a semantic segmentation module 235, and a visual inertial odometry (VIO) module 240. The components disposed external to UAVs 105 include an end user computing device 201 that communicates with a backend management system 202 of the UAV delivery service.

In the illustrated embodiment, a site designer agent capable of planning deployment layouts of UAV ground assets includes a client-side module 203A operating on computing device 201 and a server-side module 203B operating at backend management system 202. Collectively, modules 203A and 203B are referred to as site designer agent 203. In one embodiment, client-side module 203A is an application. In other embodiments, client-side module 203A is a web-based portal for accessing server-side module 203B.

Returning to the components disposed onboard UAVs 105, an onboard camera system 205 is disposed with a downward looking orientation to acquire aerial images 207 of the ground area below it. Aerial images 207 may be acquired at a regular video frame rate (e.g., 20 f/s, 30 f/s, etc.) and a subset of the images provided to the various machine vision modules 220 for analysis. In one embodiment, onboard camera system 205 is a stereovision camera system. While capturing aerial images 207, the camera intrinsics along with sensor readings from the onboard perception sensors 218 may be recorded and indexed to aerial images 207. For example, IMU 210 may include one or more of an accelerometer, a gyroscope, or a magnetometer to capture accelerations (linear or rotational), attitude, and heading readings. GNSS sensor 215 may be a global positioning system (GPS) sensor, or otherwise, and output longitude/latitude position, mean sea level (MSL) altitude, heading, speed over ground (SOG), etc. Air speed sensor 216 captures air speed of UAV 105 while underway, which may serve as a rough approximation for SOG when adjusted for weather conditions. Altimeter 217 measures air pressure, which provides MSL altitude, which may be offset using elevation map data to estimate above ground level (AGL) altitude.

During flight missions, machine vision modules 220 are operated as part of an onboard machine vision system and may constantly receive aerial images 207 and detect, identify, and track objects represented in those aerial images. Stereovision perception module 230 analyzes parallax between stereovision aerial images acquired by onboard camera system 205 to estimate distance to pixels/features/objects in aerial images 207. These stereovision depth estimates may be referred to as a stereovision depth map. VIO module 240 estimates the three-dimensional (3D) pose (e.g., position/orientation) of onboard camera system 205 of UAV 105 using aerial images 207 and IMU 210. In other words, VIO module 204 provides ego-motion tracking relative to the surrounding environment of UAV 105. Semantic segmentation module 235 uses image segmentation to inform object detection and identification (e.g., pixelwise classification) along with feature tracking within aerial images 207. Feature tracking includes the detection and tracking of features within aerial images 207. Features may include edges, corners, high contrast points, etc. of objects within aerial images 207.

Recognized objects may be tracked and the classifications provided to other modules responsible for making real-time flight decisions. In one embodiment, specialty instances of semantic segmentation modules 235, referred to as object detection modules, may be trained to perform object detection of objects that are commonly referenced by the aerial delivery service. These object detection modules may include an autoloader detector model having a neural network trained to detect autoloaders 112 of the UAV delivery service, a charge pad detector model having a neural network trained to detect staging pads 113 (also referred to as charging or landing pads) of the UAV delivery service, a fiducial detector model having a neural network trained to detector fiducial navigation markers 114, or otherwise.

Collectively, machine vision modules 220 provide vision-based analysis and understanding of the surrounding environment, which may be used by navigation controller 225 to inform navigation decisions, and perform UAV localization, automated obstacle avoidance, route traversal, etc. Of course, the outputs from machine vision modules 220 may be combined with, or considered in connection with, real-time data from any of perception sensors 218 by navigation controller 225 to make informed vision-based navigation decisions. One of these informed vision-based navigation decisions is navigation relative to assets of the UAV delivery service deployed at terminal area 100 (e.g., landing pads, fiducial navigation markers, etc.) or UAS ground assets deployed at a waypoint pickup location 101.

In the illustrated embodiment, UAV 105 further includes a shadow remover 250, which is a software module capable of analyzing aerial images 207, identifying shadows, and pre-processing aerial images 207 by removing identified shadows from aerial images 207 in preparation for downstream processing by machine vision modules 220. In one embodiment, shadow remover 205 is a neural network that has been trained to perform onboard inference on UAVs 105 to remove shadows in aerial images 207. This training may be achieved using a generative adversarial network (GAN). Site designer agent 203 may help collect the dataset used to train shadow remover 205. For example, its knowledge of when and where shadows appear at a given physical site 150 may help build {shadow, no shadow} training data pairs. The operations of shadow remover 250 may be further informed by a shadow schedule 255 output from site designer agent 203. Shadow schedule 255 provides a schedule of which UAS ground assets at physical site 150 are obscured by a shadow and at what times/seasons. In one embodiment, shadow schedule 255 may further inform UAV 105 on additional characteristics of the shadows (e.g., partial coverage, full coverage, light shadow, dark shadow, etc.). In other words, shadow schedule 255 helps shadow remover 250 identify when and which UAV ground assets captured in aerial images 107 should be preprocessed to remove a shadow, thereby improving operation of the downstream machine vision modules 220. Since shadow remover 250 performs a two part operation: 1) detection of shadows and 2) removal of shadows, shadow schedule 255 alleviates the processing burden associated with detection of shadows.

FIG. 2B is a functional block diagram illustrating a system 260 for deployment planning of UAV ground assets, in accordance with an embodiment of the disclosure. System 260 includes a site designer agent 262 and a tools library 264. The illustrated embodiment of site designer agent 262 includes an artificial intelligence (AI) language model (LM) 266 and a visual language model (VLM) 268. Site designer agent 262 is a possible AI implementation of site designer agent 203 illustrated in FIG. 2A. The illustrated embodiment of tools library 264 includes an online maps portal 270, a geostore 272, a shadow mapper 274, an aggregator tool 276, and other tools 278. The online maps portal 270, shadow mapper 274, aggregator tool 276, and other tools 278 may be implemented as callable functions, application programming interfaces (APIs), or otherwise. Geostore 272 stores or provides access to geospatial data such as a digital surface model (DSM) 280, an elevation map 282, overhead images 284, and semantic segmentations 286. In one embodiment, geostore 272 is also a callable function, API, or the like.

In one embodiment, site designer agent 262 is an AI agent adapted for receiving a user request (e.g., user prompt 288) along with system instructions 289 and responding without human intervention. Site designer agent 262 leverages the reasoning ability of AI LM 266, which may be a large language model (LLM), to understand the user request (e.g., a request for help planning the deployment of one or more UAS ground assets of a UAV delivery service at a physical site) and determine which tools in tools library 264 should be used to facilitate site planning. AI LM 266 calls the various library tools to generate raster maps related to various deployment policies, which it determines are necessary for proper deployment planning at physical site 150. VLM 268 interprets the visual geospatial data in geostore 272 and raster maps generated by AI LM 266 to generate placement guidance 290, and even provide a textual explanation 292 of its placement guidance. AI LM 266 may be implemented using one of several commercially available LLMs and similarly VLM 268 may also be implemented using a commercially available VLMs. In one embodiment, AI LM 266 and VLM 268 may be separate models as illustrated, or the same multi-model model (e.g., Gemini, GPT-4, Llama, etc.). VLM 268 may be fine-tuned to improve the quality or relevance of generated descriptions for an aggregated map, help answer questions of the user regarding placement guidance 290, or improve visual reasoning of the specific geospatial use case described herein.

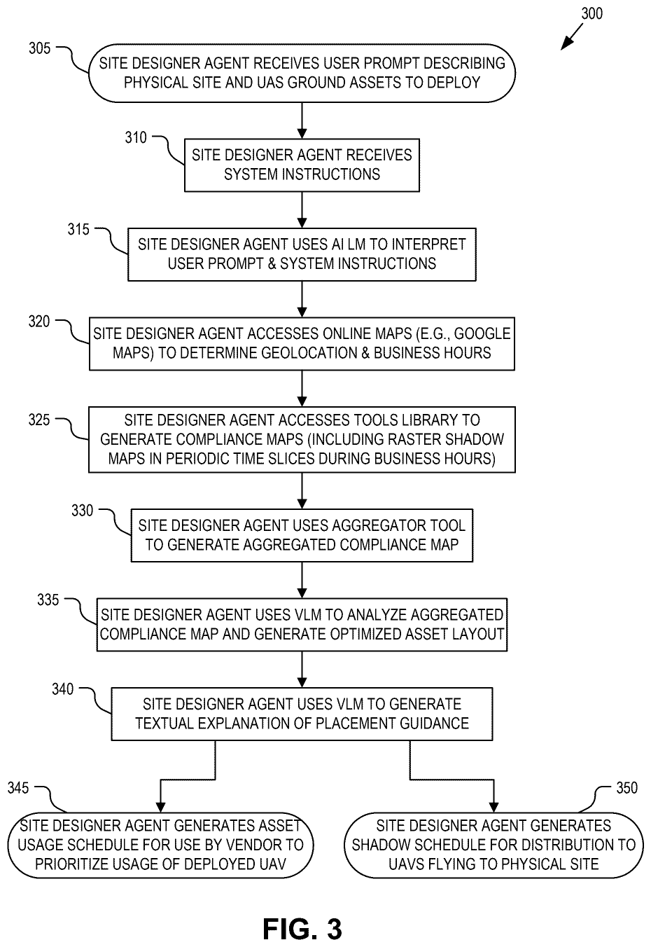

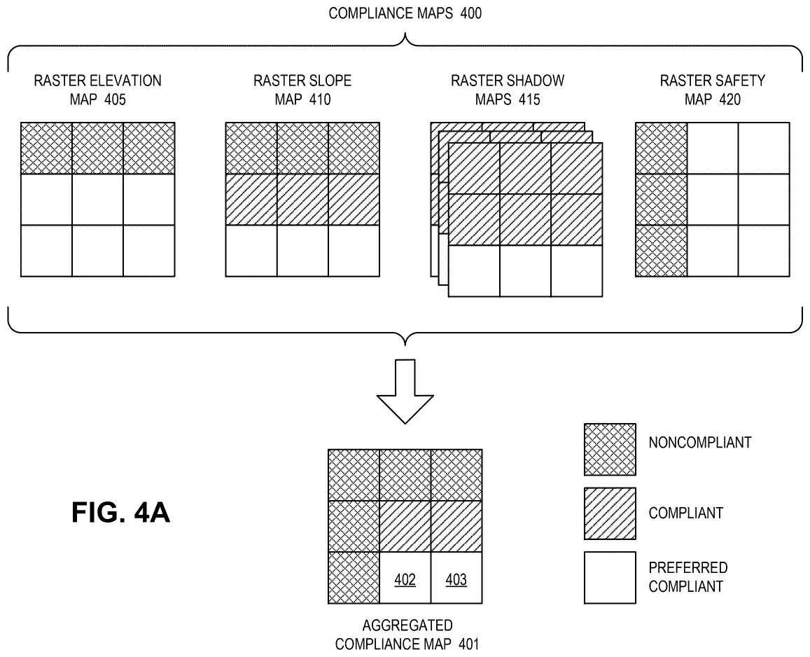

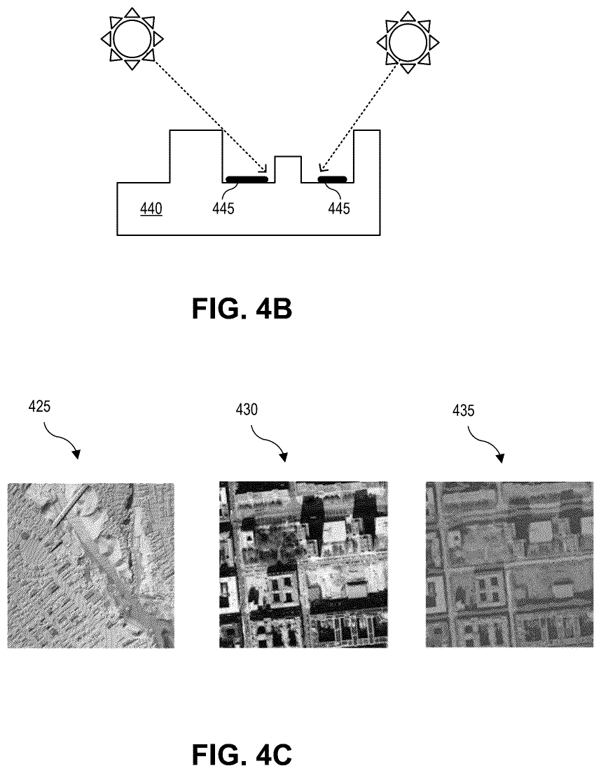

FIG. 3 is a flow chart illustrating a process 300 for deployment planning of UAS ground assets to physical site 150, in accordance with an embodiment of the disclosure. Process 300 is described with reference to FIGS. 2B and 4A-C. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel. Some process blocks may even be omitted as optional.

In a process block 305, the deployment planning begins when a user (e.g., vendor/employee of business 155) generates a user prompt 288 and inputs it into client-side module 203A for receipt by site designer agent 262. In one embodiment, user prompt 288 is a textual input that identifies physical site 150 and one or more UAS ground assets planned for deployment at physical site 150. For example, UAS ground assets may include one or more autoloaders 112, staging pads 113, navigation fiducial markers 114, etc. The identification of the UAS ground assets may include asset type(s) and/or number of each asset type to deploy. An example of user prompt 288 is:
We want to setup three autoloaders in the parking lot of the Acme Corp located at the Great American Mall in Hope Springs, KS. Ideally, the autoloaders will be less than 10 m away from the entry door.

In a process block 310, site designer agent 262 receives, or otherwise accesses, user prompt 288 and system instructions 289. System instructions 289 describe deployment policies for the UAS ground assets and further describes tools library 264 and its available tools to site designer agent 262. Tools library 264 includes the resources and software tools that site designer agent 262 is provided to facilitate deployment planning. In one embodiment, system instructions 289 are specified by the UAV service and not editable (or even accessible) by the end user. System instructions 289 may vary depending upon the type of physical site 150 being planned (e.g., is physical site 150 a local nest 100, a waypoint pickup area 101, etc.). An example of system instructions 289 for a waypoint pickup area 101 is:
To setup a waypoint pickup area, autoloaders must be placed on a flat, level, hard ground surface such as concrete or asphalt. Autoloaders should be placed on a ground surface with a light color if available, dark colors are discouraged because of exposure issues with UAV machine vision cameras. Areas covered by shadows during business hours should be avoided. You have access to the following tools:
   {Online Maps Portal}
   {Geostore}
   {Shadow Mapper}
   {Elevation Mapper}{Slope Mapper}{Safety Mapper}{Aggregator Tool}The list of available tools in tools library 264 may include additional instructions related to access protocols, input fields, output fields, and other instructions describing how to use these tools. In one embodiment, system instructions 289 may include a repository of examples (e.g., ground truth data) of preplanned or human planned UAV hubs (e.g., local nests, waypoint pickup areas, etc.) from which to learn.

With user prompt 288 and system instructions 289 available, site designer agent 262 can interpret the request defined in the user prompt 288 (process block 315). As discussed above, the illustrated embodiment of site designer agent 262 includes AI LM 266 and VLM 268. AI LM 266 connects the user request and system instructions to the available tools in tools library 264. In essence, AI LM 266 is the “thinking and planning” part of site designer agent 262. In one embodiment, AI LM 266 is a LLM.

In a process block 320, AI LM 266 determines the geolocation of physical site 150 and the business hours of the business 155 located there by calling online maps portal 270. Online maps portal 270 provides the geolocation (e.g., latitude, longitude, altitude) and business hours (e.g., M-F 8 am to 8 pm, Sat 9 am to 4 pm, Sun closed) in response to generalized description of the business presented in user prompt 288. In one embodiment, online maps portal 270 may be implemented using Google Maps.

With the geolocation and business hours determined, site designer agent 262 calls the various tools of tools library 264 to generate compliance maps 400 and an aggregated compliance map 401 (process block 325; also see FIG. 4A). In the illustrated embodiment, compliance maps 400 each indicate a sort of grid-based compliance of physical site 150 to an associated one of the deployment policies specified in one or both of user prompt 288 and/or system instructions 289 and for which a library tool is provided. AI LM 266 uses the geospatial data available via geostore 272 along with the other tool APIs to generate the individual compliance maps including: a raster elevation map 405, a raster slope map 410, raster shadow maps 415, raster safety map 420, or otherwise. In the illustrated embodiment, compliance maps 400 separate physical site 150 into a common grid and indicate the noncompliance, compliance, or preferred compliance of each grid section with the associated policy. Accordingly, in one embodiment, the individual compliance maps 400 are referred to as raster maps where each grid element or pixel corresponds to a specific portion of physical site 150 and has an associated value indicating a level of compliance or noncompliance. In one embodiment, each of the raster maps may be considered a sort of compliance heat map.

FIG. 4A illustrates four example types of compliance maps 400. The first two compliance maps are raster elevation map 405 and raster slope map 410. AI LM 266 may call an elevation and slope tool (e.g., one of the other tools 278), which accesses reference elevation map 282 (e.g., see elevation map 425 in FIG. 4C) and/or DSM 280 to generate both raster elevation map 405 and raster slope map 410. The value of each grid section within raster elevation map 405 indicates a level of compliance of the corresponding geography to an elevation policy. Similarly, the value of each grid section within raster slope map 410 indicates a level of compliance of the corresponding geography to a slope policy (e.g., 0% grade is preferred, <2% grade is compliant, >2% is non-compliant or otherwise). These policies may be incorporated into system instructions 289 and/or embedded within the individual tools themselves.

In another example, other tools 278 may include a safety tool that accesses any or all of the geospatial data to determine location specific compliance with safety policies. These safety policies may include minimum offsets from pedestrian thoroughfares, fire hydrants, buffer zones to ingress/egress doors, etc. The overhead images 284 and the semantic segmentations 286, which identify and classify pixels/objects may be referenced by any of the library tools including a safety tool. FIG. 4C illustrates example overhead image 430 and semantic segmentation 435, which may be analyzed by library tools when generating a safety compliance map.

Compliance maps 400 illustrated in FIG. 4A are intended to represent a non-exhaustive list of example compliance maps, and other tools 278 presented in FIG. 2B explicitly contemplates the extensibility of tool library 264 to analyze and consider a host of factors when planning for the deployment of new UAV ground assets. For example, other tools 278 may include various API tools for generating raster maps related to elevation policies, slope policies, safety policies, GNSS availability, power availability, data connection availability, efficiency policies, etc.

One notable tool of tools library 264 is shadow mapper 274. Shadow mapper 274 enables the shadow-aware planning, deployment, and operation of the UAS ground assets. When invoked by AI LM 266, shadow mapper 274 accesses DSM 280 via geostore 272 when generating raster shadow maps 415. Shadow mapper 274 uses the geolocation data obtained in process block 320 along with DSM 280 to determine the location of the sun and ray cast sunlight, and by extension shadows, onto a surface model of physical site 150. FIG. 4B illustrates how the sun position can be referenced to cast rays onto a surface model 440 of a portion of DSM 280 to cast shadows 445 and identify shadow locations. The cast shadows 445 at a given time (i.e., for a given sun location) may then be used to generate a particular raster shadow map 415 for the physical site 150 at the given time. Ray casting sunlight at physical site 150 may be repeated for different sun locations at different times to generate a set of raster shadow maps 415. The raster shadow maps 415 may be generated in periodic time slices (e.g., 15 min increments, one-hour increments, etc.) over the course of the business hours such that each raster shadow map 415 corresponds to a particular time in periodic time slices. The periodic time slices may be distributed over the business hours such that cumulative shadow impact during the business hours may be determined and the locations with the greatest shadow impact may be identified and avoided when placing the UAS ground assets.

Returning to FIG. 3, once the individual compliance maps 400 have all been determined, AI LM 266 can invoke aggregator tool 276, which combines all of the compliance maps 401 into a single aggregated compliance map 401 (process block 330). In the illustrated embodiment, aggregated compliance map 401 is itself a form of heat map presenting a graduated scheme (e.g., preferred, compliant, and non-compliant) of grid-based compliance to recommended specific placements of the UAS ground assets at physical site 150. In one embodiment, aggregator tool 276 may apply a weighting algorithm when combining compliance maps 400. The weighting algorithm may apply equal or non-equal weights between the compliance maps 400. For example, the raster safety map 420 may be given a higher weight than the raster elevation map 405. In other embodiments, aggregator tool 278 may apply a cumulative algorithm, a cumulative threshold algorithm, or otherwise.

Once aggregated compliance map 401 is computed, VLM 268 may be invoked to visually interpret aggregated compliance map 401 and generate placement guidance 290 (process block 335). Placement guidance 290 may include a visual placement map, a textual guidance, or both. Accordingly, VLM 268 can analyze user prompt 288, system instructions 289, and aggregated compliance map 401 to provide placement guidance 290. The visual-language based reasoning of VLM 268 may further generate textual explanation 292 explaining or justifying its placement guidance (process block 340). In particular, VLM 268 may analyze the individual compliance maps 400 to explain why a particular spot at physical site 150 is to be avoided. For example, VLM 268 may analyze raster slope map 410 and explain that the ground corresponding to the top row grid locations is too steep and adversely affected by shadows, while grid locations 402 and 403 are flat, safe, and free of shadows during business hours. Inclusion of textual explanation 292 can encourage adoption of the placement guidance 290, or help end users identify flawed reasoning by site designer agent 262, both of which are expected to encourage usage adoption of site designer agent 262 by vendors. Enabling the end user to identify flawed reasoning can then be used to improve site designer agent 262. The aggregated compliance map 401, textual explanation 292, and user feedback/quality score is referred to as a preference alignment dataset, which may be used to improve VLM 268 using Parameter-Efficient Fine-Tuning (PEFT).

In the illustrated embodiment, AI LM 266 oversees generation of compliance maps 400 and aggregated compliance map 401 using tools library 264 while VLM 268 analyzes the user prompt 288, system instructions 289, compliance maps 400, and aggregated compliance map 401 to generate the placement guidance 290 and textual explanation 292 thereof. Of course, in other embodiments, site designer agent 262 may use a single model as opposed to two distinct models, to perform the reasoning necessary to leverage the available tools and generate placement guidance 290 and textual explanation 292.

In addition to generating placement guidance 290 and textual explanation 292, site designer agent 262 may also generate an asset usage schedule 296 (process block 345) and/or a shadow schedule 255 (process block 350). In situations where there are insufficient shadow free locations at physical site 150 during the entire business hours, shadow schedule 255 indicates when shadows cover which of the UAS ground assets once deployed to their specified locations. Shadow schedule 255 is then distributed to UAVs 105 operating over physical site 150 to facilitate shadow-aware vision-based navigation of those UAVs relative to the UAS ground assets. In particular, the onboard shadow remover 250 can reference shadow schedule 294 to increase its awareness of when and where shadows will be present during operation. Asset usage schedule 296 can be referenced by business 155 and its staff to prioritize usage of the deployed UAS ground assets and improve efficiency and reliability. For example, if a given UAS ground asset will be shaded during a predetermined time window each day, then the schedule may prioritize using the other non-shaded UAS ground assets during this time window. In this manner, not only is UAS asset placement shadow-aware, but the asset usage by ground attendants and the UAV vision-guidance systems onboard UAV 105 are also shadow-aware.

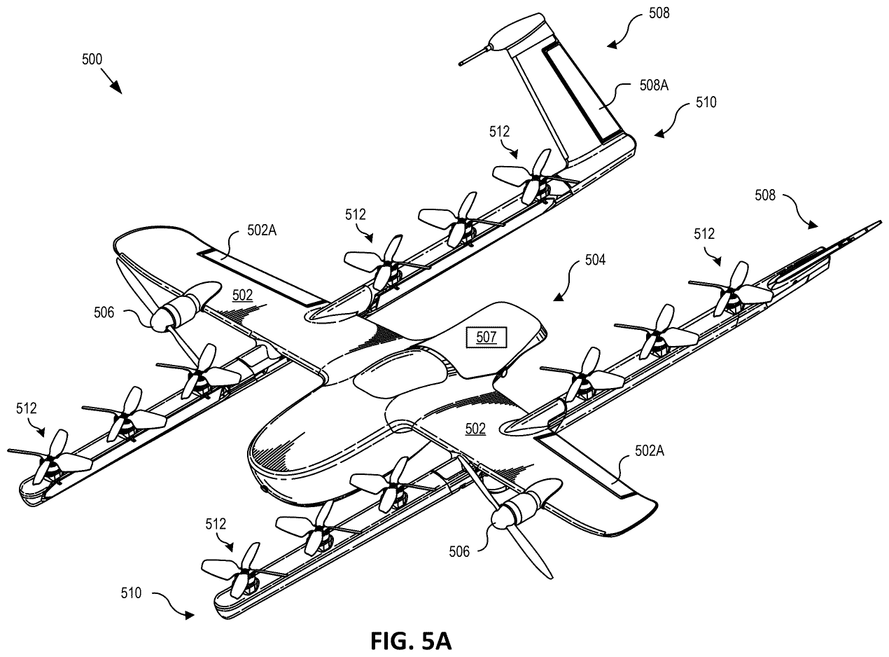

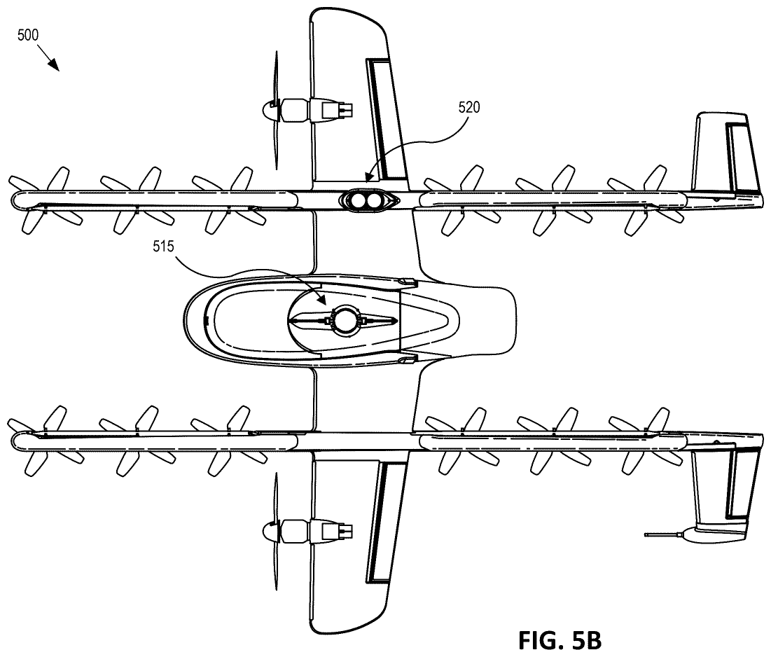

FIGS. 5A and 5B illustrate a UAV 500 that is well-suited for use with a UAV delivery service for aerial delivery of packages, in accordance with an embodiment of the disclosure. FIG. 5A is a topside perspective view illustration of UAV 500 while FIG. 5B is a bottom side plan view illustration of the same. UAV 500 is one possible implementation of UAVs 105 illustrated in FIG. 1A, although other types of UAVs may be implemented for a UAV delivery service as well.

The illustrated embodiment of UAV 500 is a vertical takeoff and landing (VTOL) UAV that includes separate propulsion units 506 and 512 for providing horizontal and vertical propulsion, respectively. UAV 500 is a fixed-wing aerial vehicle, which as the name implies, has a wing assembly 502 that can generate lift based on the wing shape and the vehicle's forward airspeed when propelled horizontally by propulsion units 506. The illustrated embodiment of UAV 500 has an airframe that includes a fuselage 504 and wing assembly 502. In one embodiment, fuselage 504 is modular and includes a battery module, an avionics module, and a mission payload module. These modules are secured together to form the fuselage or main body.

The battery module (e.g., fore portion of fuselage 504) includes a cavity for housing one or more batteries for powering UAV 500. The avionics module (e.g., aft portion of fuselage 504) houses flight control circuitry of UAV 500, which may include a processor and memory, communication electronics and antennas (e.g., cellular transceiver, wifi transceiver, etc.), and various sensors (e.g., GNSS sensor, an inertial measurement unit, a magnetic compass, a radio frequency identifier reader, etc.).

Collectively, these functional electronic subsystems for controlling UAV 500, communicating, and sensing the environment may be referred to as a control system 507. The mission payload module (e.g., middle portion of fuselage 504) houses equipment associated with a mission of UAV 500. For example, the mission payload module may include a payload actuator 515 (see FIG. 5B) adapted for holding and releasing an externally attached payload (e.g., package for delivery) and automated pickup of packages from an autoloader. In some embodiments, the mission payload module may include camera/sensor equipment (e.g., camera, lenses, radar, lidar, pollution monitoring sensors, weather monitoring sensors, scanners, etc.). In FIG. 5B, an onboard camera 520 (e.g., onboard camera system 205) is mounted to the underside of UAV 500 to support a computer vision system (e.g., stereoscopic machine vision) for visual triangulation/localization and navigation as well as operate as an optical code scanner for reading visual codes affixed to packages. Of course, onboard camera 520 may alternatively be integrated within fuselage 504.

As illustrated, UAV 500 includes horizontal propulsion units 506 positioned on wing assembly 502 for propelling UAV 500 horizontally. UAV 500 further includes two boom assemblies 510 that secure to wing assembly 502. Vertical propulsion units 512 are mounted to boom assemblies 510 and provide vertical propulsion. Vertical propulsion units 512 may be used during a hover mode where UAV 500 is descending (e.g., to a delivery zone), ascending (e.g., at initial launch or following a delivery), or maintaining a constant altitude. Stabilizers 508 (or tails) may be included with UAV 500 to control pitch and stabilize the aerial vehicle's yaw (left or right turns) during cruise. In some embodiments, during cruise mode vertical propulsion units 512 are disabled or powered low and during hover mode horizontal propulsion units 506 are disabled or powered low.

During flight, UAV 500 may control the direction and/or speed of its movement by controlling its pitch, roll, yaw, and/or altitude. Thrust from horizontal propulsion units 506 is used to control air speed. For example, the stabilizers 508 may include one or more rudders 508A for controlling the aerial vehicle's yaw, and wing assembly 502 may include elevators for controlling the aerial vehicle's pitch and/or ailerons 502A for controlling the aerial vehicle's roll. Rudders 508A and ailerons 502A are referred to as control surfaces. While the techniques described herein are particularly well-suited for VTOLs providing an aerial delivery service, it should be appreciated that the techniques described herein are generally applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 5A and 5B illustrate one wing assembly 502, two boom assemblies 510, two horizontal propulsion units 506, and six vertical propulsion units 512 per boom assembly 510, it should be appreciated that other variants of UAV 500 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A computer-readable medium includes any mechanism that provides (i.e., stores) information in a non-transitory form accessible by a machine (e.g., a computer, network device, personal digital assistant, manufacturing tool, any device with a set of one or more processors, a networked system of device, etc.). For example, a machine-readable medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A computer implemented method of an unmanned aerial vehicle (UAV) service, the computer implemented method comprising:
receiving a user prompt and system instructions by a site designer agent, wherein the user prompt identifies a physical site and an unmanned aircraft system (UAS) ground asset of the UAV service planned for deployment at the physical site, and wherein the system instructions describe deployment policies for the UAS ground asset and a tools library available to the site designer agent that facilitates deployment planning of the UAS ground asset;
generating, by the site designer agent using the tools library and geospatial data associated with the physical site, compliance maps, wherein the compliance maps each indicate a grid-based compliance of the physical site to an associated one of the deployment policies;
generating an aggregated compliance map for the UAS ground asset at the physical site based upon an aggregation of the compliance maps; and
generating, by the site designer agent, placement guidance indicating where to deploy the UAS ground asset at the physical site based at least on the aggregated compliance map, wherein the placement guidance indicates where to deploy the UAS ground asset to support UAV operations at the physical site.

2. The computer implemented method of claim 1, wherein the site designer agent includes, or is otherwise adapted to access, both an artificial intelligence (AI) language model to which the user prompt and the system instructions are provided and a vision language model (VLM) for generating the placement guidance.

3. The computer implemented method of claim 2, further comprising:
generating a textual explanation of the placement guidance using the VLM, wherein the textual explanation is generated based at least on the compliance maps.

4. The computer implemented method of claim 1, wherein the tools library comprises a geostore and a shadow mapper, the computer implemented method further comprising:
obtaining the geospatial data of the physical site via the geostore;
ray casting sunlight at the physical site with the shadow mapper based on the geospatial data; and
generating a raster shadow map of the physical site based on the ray casting,
wherein the placement guidance is shadow-aware of the physical site.

5. The computer implemented method of claim 4, further comprising:
generating a plurality of raster shadow maps, including the raster shadow map, in periodic time slices each corresponding to a different sun location relative to the physical site.

6. The computer implemented method of claim 5, further comprising:
determining a geolocation of the physical site identified in the user prompt using an online mapping service; and
determining business hours of a business operating at the physical site using the online mapping service,
wherein the periodic time slices are distributed over business hours and the placement guidance accounts for a cumulative shadow impact during the business hours.

7. The computer implemented method of claim 5, further comprising:
generating a shadow schedule indicating when shadows cover the UAS ground asset once deployed to a specified location at the physical site; and
providing the shadow schedule to a UAV of the UAV service to facilitate shadow-aware vision-based navigation of the UAV relative to the UAS ground asset.

8. The computer implemented method of claim 1, further comprising:
generating an asset usage schedule that prioritizes usage of the UAS ground asset amongst a plurality of UAS ground assets deployed at the physical site based on one or more of the compliance maps.

9. The computer implemented method of claim 1, wherein the compliance maps include two or more of:
a raster shadow map indicating the grid-based compliance of the physical site to a shadow coverage policy for the UAS ground asset;
a raster elevation map indicating the grid-based compliance of the physical site to an elevation policy for the UAS ground asset;
a raster slope map indicating the grid-based compliance of the physical site to a slope policy for the UAS ground asset; or raster safety map indicating the grid-based compliance of the physical site to a safety policy for the UAS ground asset.

10. The computer implemented method of claim 1, wherein the system instructions are specified by the UAV service.

11. The computer implemented method of claim 1, wherein the aggregated compliance map comprises a heat map indicating one or more of noncompliant locations, compliant locations, or preferred compliant locations.

12. At least one computer-readable medium storing instructions that, when executed by a computing system, will cause the computing system to perform operations comprising:
receiving a user prompt and system instructions by a site designer agent, wherein the user prompt identifies a physical site and an unmanned aircraft system (UAS) ground asset of an unmanned aerial vehicle (UAV) service planned for deployment at the physical site, and wherein the system instructions describe deployment policies for the UAS ground asset and a tools library available to the site designer agent that facilitates deployment planning of the UAS ground asset;
generating, by the site designer agent using the tools library and geospatial data associated with the physical site, compliance maps, wherein the compliance maps each indicate a grid-based compliance of the physical site to an associated one of the deployment policies;
generating an aggregated compliance map for the UAS ground asset at the physical site based upon an aggregation of the compliance maps; and
generating, by the site designer agent, placement guidance indicating where to deploy the UAS ground asset at the physical site based at least on the aggregated compliance map, wherein the placement guidance indicates where to deploy the UAS ground asset to support UAV operations at the physical site.

13. The at least one computer-readable medium of claim 12, wherein the site designer agent includes, or is otherwise adapted to access, both an artificial intelligence (AI) language model to which the user prompt and the system instructions are provided and a vision language model (VLM) for generating the placement guidance.

14. The at least one computer-readable medium of claim 13, further comprising:
generating a textual explanation of the placement guidance using the VLM, wherein the textual explanation is generated based at least on the compliance maps.

15. The at least one computer-readable medium of claim 12, wherein the tools library comprises a geostore and a shadow mapper, the computer implemented method further comprising:
obtaining the geospatial data of the physical site via the geostore;
ray casting sunlight at the physical site with the shadow mapper based on the geospatial data; and
generating a raster shadow map of the physical site based on the ray casting,
wherein the placement guidance is shadow-aware of the physical site.

16. The at least one computer-readable medium of claim 15, further comprising:
generating a plurality of raster shadow maps, including the raster shadow map, in periodic time slices each corresponding to a different sun location relative to the physical site.

17. The at least one computer-readable medium of claim 16, further comprising:
determining a geolocation of the physical site identified in the user prompt using an online mapping service; and
determining business hours of a business operating at the physical site using the online mapping service,
wherein the periodic time slices are distributed over business hours and the placement guidance accounts for a cumulative shadow impact during the business hours.

18. The at least one computer-readable medium of claim 16, further comprising:
generating a shadow schedule indicating when shadows cover the UAS ground asset once deployed to a specified location at the physical site; and
providing the shadow schedule to a UAV of the UAV service to facilitate shadow-aware vision-based navigation of the UAV relative to the UAS ground asset.

19. The at least one computer-readable medium of claim 12, further comprising:
generating an asset usage schedule that prioritizes usage of the UAS ground asset amongst a plurality of UAS ground assets deployed at the physical site based on one or more of the compliance maps.

20. The at least one computer-readable medium of claim 12, wherein the compliance maps include two or more of:
a raster shadow map indicating the grid-based compliance of the physical site to a shadow coverage policy for the UAS ground asset;
a raster elevation map indicating the grid-based compliance of the physical site to an elevation policy for the UAS ground asset;
a raster slope map indicating the grid-based compliance of the physical site to a slope policy for the UAS ground asset; or
raster safety map indicating the grid-based compliance of the physical site to a safety policy for the UAS ground asset.
